(19) United States
(12) Patent Application Publication
(10) Pub. No.: US 2015/0048211 A1
(43) Pub. Date: Feb. 19, 2015

(54) Padded Shoulder Garment Used to Pack Parachutes

(71) Applicant: Roberto Eugenio Alamanos Martinez, Miami, FL (US)

(72) Inventor: Roberto Eugenio Alamanos Martinez, Miami, FL (US)

(21) Appl. No.: 13/968,926

(22) Filed: Aug. 16, 2013

(51) Int. Cl. B64D 17/30

(52) U.S. Cl. CPC B64D 17/30
USPC 244/151 R

(57) ABSTRACT

A padded shoulder garment used to pack parachute, the padded shoulder garment comprises of a strap, the strap has a left and a right side, and a middle section; a pair of sleeves, each sleeve is defined on each side of the strap; and a pair of pads, each pad is adjacent to each sleeve and is attached to the strap.

### BACKGROUND

The present invention is directed to a padded shoulder garment that is used to pack a parachute when pro or oil packing.

There are various methods of packing a parachute. The present invention is used when pro packing or roll packing a parachute. Both of these methods usually require the packer to place the lines over his or her shoulder while packing a parachute.

A tension is created between the packer and the parachute canopy when the tines are placed over the shoulders of the packer. The tension allows the packer to keep the lines straight while he or she is organizing the lines that will be placed within the parachute canopy. The tension created tends to burn the packer's shoulders and trapezius areas hen the parachute is packed.

The present invention is a padded shoulder garment that allows the weight of the lines of the parachute to be dispersed on to its pads rather than on to the packer's shoulders and trapezius areas, thereby preventing the rope/line burning of the shoulders and the trapezius areas of the packer due to the friction that is normally caused between the line and the packer's body.

For the foregoing reasons, there is a need for a padded shoulder garment that will prevent the burning of the shoulder and trapezius areas of a packer when roll or pro packing a parachute.

### SUMMARY

The present invention is directed to a device that will prevent the burning of the shoulder and trapezius areas of a packer when roll or pro packing a parachute.

The device comprises of a strap which is made of an elastic material. The strap has a left and a right side and a middle section. Each side of the strap defines a sleeve. The sleeves are made of an elastic material. Adjacent to each sleeve there is a pad that is sewn onto the strap. The pads are isosceles triangularly shaped, the longer side of each pad is adjacent to the sleeves and the shorter sides are directed toward the middle section of the strap. The pads are covered by a synthetic leather, a leather, or a polymeric material,

The device drapes on the shoulders and trapezius areas of the user after the arms of the user have been placed through the sleeves. The elastic material of the strap pulls the sleeves toward the middle section of the strap and provides the tension required to maintain the pads over the shoulder and trapezius areas of the user.

An object of the present invention is to prevent the shoulders or trapezius areas of a packer from being burnt when packing a parachute.

Another object of the present invention is to prevent clothing worn by a packer of a parachute from being worn in the areas of the clothing that cover the shoulder and trapezius areas of the user so that they do not tear.

Yet another Object of the present invention is that the elastic material allows for different user body types to wear the protective garment.

Still a further object of the present invention is to provide a packer with a lightweight padded shoulder garment.

### DRAWINGS

These and other features, aspects, and advantages of the present invention will become better understood with regard to the following description, appended claims, and drawings where:

FIG. 1 shows a top plan view of the present invention;

FIG. 2 shows a bottom plan view of the present invention;

FIG. 3 shows a perspective view of the present invention; and

FIG. 4 shows a perspective view of the present invention, wherein the invention is draped over the shoulders of a user.

### DESCRIPTION

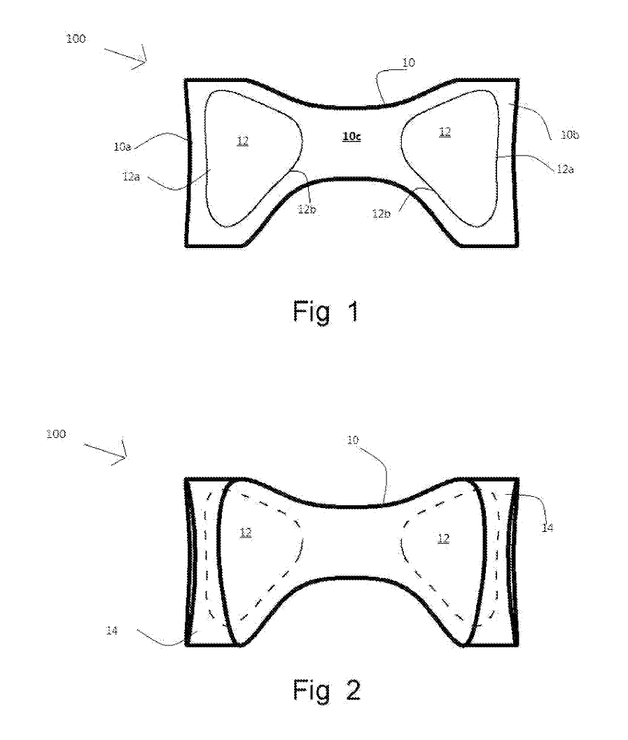

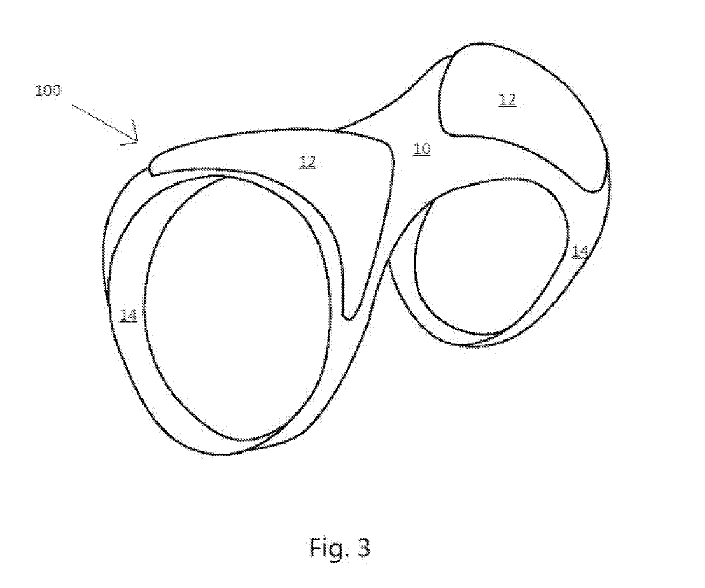

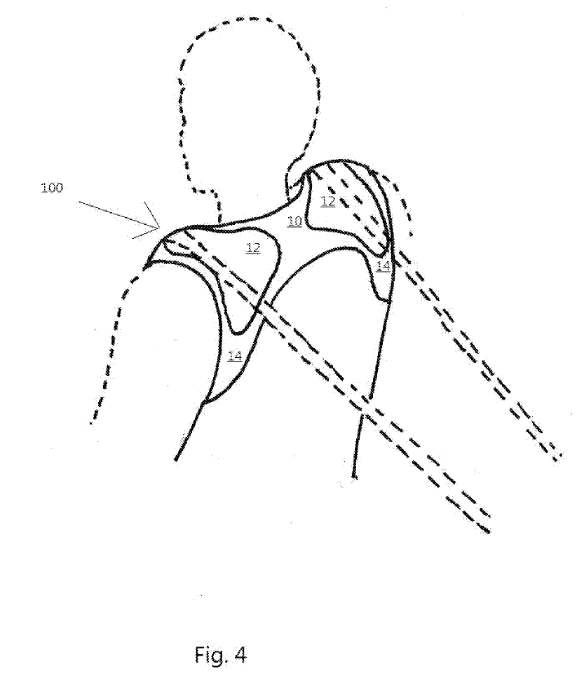

As seen in FIGS. 1-3, the padded shoulder garment 100 used to pack parachutes of the present invention comprises of a strap 10 which is made of an elastic material. The strap 10 has a left 10a and a right side 10b and a middle section 10c. Each side 10a/10b of the strap defines a sleeve 14. The sleeves 14 are made of an elastic material. Adjacent to each sleeve 14 there is a pad 12 that is sewn onto the strap 10. In an embodiment of the present invention, the pads 12 are isosceles triangularly shaped, and the longer side 12a of each pad 12 is adjacent to the sleeves 14 and the shorter sides 12b are directed toward the middle section 10c of the strap 10. The pads might be covered by material made of a synthetic leather, a leather, or a polymeric material.

An advantage of the present invention is that it prevents the shoulders or trapezius areas of a packer from being burn then packing a parachute.

Another advantage of the present invention is that it prevents clothing worn by a packer of a parachute from wearing in the areas of the clothing that cover the shoulder and trapezius areas of the user so that they do not tear.

Yet another advantage of the present invention is that the elastic material allows for different user body types to wear the protective garment.

Still a further advantage of the present invention is that it provides a packer with a lightweight padded shoulder garment.

Although the present invention has been described in considerable detail in reference to preferred versions, other versions are possible. Therefore, the spirit and scope of the appended claims should not be limited to the description of the preferred versions contained herein.

What is claimed is:

1. A padded shoulder garment used to pack parachute, the padded shoulder garment comprises of
a strap, the strap has a left and a right side, and a middle section;
a pair of sleeves, each sleeve is defined on each side of the strap; and
a pair of pads, each pad is adjacent to each sleeve and is attached to the strap.

2. The padded shoulder garment of claim 1, wherein each pad each pad is isosceles triangularly shaped and the longer side of each pad is adjacent to each sleeve and the shorter sides are directed toward the middle section of the strap

3. The padded shoulder garment of claim 2, wherein the strap is made of an elastic material.

4. The padded shoulder garment of claim 3, wherein the pads are sewn on the strap.

5. The padded shoulder garment of claim 4, wherein the pads are covered by a material that is a polymer.

6. The padded shoulder garment of claim 4, wherein the pads are covered by a material that is made of leather.

7. The padded shoulder garment of claim 4, wherein the pads are covered by a material that is made of synthetic leather.
